(19) United States
(12) Patent Application Publication
(10) Pub. No.: US 2023/0323249 A1
(43) Pub. Date: Oct. 12, 2023

(54) LAUNDRY DETERGENT COMPOSITION

(71) Applicant: Conopco, Inc., d/b/a UNILEVER, Englewood Cliffs, NJ (US)

(72) Inventors: Andrew David GREEN, Dobshill (GB); Alyn James PARRY, Neston (GB)

(73) Assignee: Conopco, Inc., d/b/a UNILEVER, Englewood Cliffs, NJ (US)

(21) Appl. No.: 18/020,275

(22) PCT Filed: Jul. 26, 2021
(86) PCT No.: PCT/EP2021/070778

§ 371 Date: Feb. 8, 2023

(30) Foreign Application Priority Data
Aug. 12, 2020 (EP) 20190667.4

(51) Int. Cl. C11D 1/83; C11D 3/33; C11D 3/20; C11D 11/00

(52) U.S. Cl. CPC C11D 3/33; C11D 1/83; C11D 3/2079; C11D 11/0017; C11D 11/0094; C11D 1/143

(57) ABSTRACT

A concentrated laundry detergent composition premix comprising 10 to 70% wt. surfactant, a fatty acid, and methyl glycine diacetic acid (MGDA), from 3 to 15% wt. hydrotrope, and having a pH of from 6 to 8.. A method for forming a laundry detergent composition by diluting such a premix in water such that the final concentration of fatty acid anti-foam is from 0.5 to 1.5% wt. A container comprising a premix.

The present invention relates to improved dilutable compositions.

WO 2011/033483 (Ecolab) discloses methods and compositions for treating non-trans fats, fatty acids and sunscreen stains with a chelating agent. The invention also relates to methods for reducing the frequency of laundry fires with a chelating agent.

WO 96/21721 (Jeyes) discloses a sealed container containing a unit dose of a liquid surfactant containing concentrate, which concentrate, on dilution with water, gives a diluted liquid product of similar or increased viscosity. The concentrate may further contain other active ingredients such as bleaching agents, disinfectants and conditioning agents. The concentrate may be adapted for application to hard surfaces such as sinks or floors or to soft surfaces such as fabrics, skin or hair.

Despite the prior art there remains a need for improved products which can be diluted by the user to form a working composition. Typically, such compositions, or premixes, are purchased by the consumer and diluted in the domestic environment. This means that the composition needs to be suitable for a range of water qualities, in particular water hardnesses. Diluting such products at home means that the consumers may introduce hardness ions into the laundry product which have a material impact on the integrity of the diluted product as any introduced calcium ions may interact with neutralised fatty acid to form compounds which can under certain conditions precipitate to give a hazy / opaque visual appearance and may risk destabilising the product.

It is also a challenge to be able to provide a premix product which is dilutable and also behaviourally acceptable to the consumer. The premix must be stable, visually clear, fragranced, preserved and with appropriate rheological profile such that it performs in a manner expected, in particular as regards an appropriate foaming in use. It is also important that it is easily dissoluble in water. While opaque formulations are used, visually clear formulations are highly desirable.

It is further highly important that the diluted product is also visually attractive and functionally adequate.

It is thus an important challenge to get a dilute at home product which is acceptable when in pre-diluted form as well as post-diluted form, is easily diluted by the consumer, and performs as a cleaning product.

Accordingly, and in a first aspect, there is provided a concentrated laundry detergent composition premix comprising 10 to 70% wt. surfactant, more preferably from 20 to 70% and most preferably from 30 to 65%, a fatty acid, from 3 to 15% wt. hydrotrope and methyl glycine diacetic acid (MGDA), and having a pH of from 6 to 8.

The concept of ‘dilute at home product’ is becoming more popular among more environmentally aware consumers. The challenge to the formulator is to make a product which has the right physical and performance characteristics during an extra phase in the product’s life cycle. Whereas previously the formulator needed to be aware of the product as sold and the product in use they now have to consider the performance of a product which is diluted by the consumer too. This becomes more difficult when one considers the role of surfactant in such detergent formulations and the manner in which they are used after dilution in the domestic environment. High levels of surfactant without suitable foam control and the product foams too readily in the wash and cleaning in horizontal axis washing machines is reduced; not enough surfactant and product will foam appropriately for in use but also does not clean. Further, the viscosity also needs careful management as the addition of water can mean a significant change in the rheological performance of the product. Accordingly, managing these new physical performance requirements becomes vital to providing an appropriate product. Such desired performance behaviours include being easily dissoluble in domestic supplied water thereby reducing the need for aggressive shaking by the consumer and so reducing the chance of excess foam being generated. Ordinarily, these are aspects which are not under the spotlight when formulating a regular liquid product.

There is also an added challenge in that the water used to dilute the premix is not controlled. Thus, the premix must be designed such that its performance is not affected by water quality, in particular hardness.

We have surprisingly found that MGDA is able to form a clear, stable premix product and which, when diluted, is also to form a stable liquid detergent composition ready for use by the consumer. The presence of MGDA also means that a higher pH can be used in order to facilitate greater inclusion of fatty acid. This increased level of fatty acid at higher pH improves its anti-foam effect during the use of the composition in the wash regime while avoiding unwanted precipitation issues in the diluted composition before use.

Preferably, the MGDA is present at from 0.1 to 3% wt. of the composition, preferably from 0.1 to 2 and more preferably from 0.2 to 1.0% wt. of the composition. More preferably, the composition comprises less than 0.1% HEDP sequestrant such as Dequest 2010.

Preferably, the fatty acid anti-foam is present at from 0.5 to 6% wt. of the composition. Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

For formula accounting purposes, in the formulation, fatty acids and/or their salts (as defined above) are not included in the level of surfactant or in the level of builder.

The pH of the composition is strictly controlled such that the pH does not change during dilution by the consumer and also provides appropriate availability of anti-foam. The pH of the premix composition is from 6 to 8 and preferably from 6.4 to 7.7. The pH may be controlled through a combination of TEA and/or fatty acid. Other buffering materials known in the art with an appropriate pKa may also be used.

Preferably, the composition comprises viscosity modifier. More preferably, the viscosity modifier comprises an ethoxylated sorbitan ester. The ethoxylated sorbitan ester provides improved rheological characteristics in the context of a product which is diluted by the consumer in the domestic environment. It should be noted that this is independent of any rheological behaviour which is affected by pouring or otherwise using the diluted product. The concentrated premix is to be diluted by the user and as such it is necessary for the premix to behave rheologically appropriately.

More preferably the ethoxylated sorbitan ester comprises from 50 to 1000 ethoxylate units, more preferably from 200 to 700 and most preferably from 300 to 550.

Preferably, the ethoxylated sorbitan ester comprises one to five, more preferably three to five fatty acid esters. More preferably, the ethoxylated sorbitan ester comprises a fatty acid having from 10 to 22 carbons, more preferably from 14 to 20 and most preferably 18 carbons. The fatty acid may be straight chain or branched, saturated or unsaturated. The most preferred fatty acid group is a stearic acid group.

The most preferred ethoxylated sorbitan ester is sorbeth-450 tristearate and which is the triester of stearic acid and a polyethylene glycol ether of sorbitol with an average of 450 moles of ethylene oxide.

Preferably the ethoxylated sorbitan ester is present at from 0.01-8.0% of the premix composition.

Rheology modifiers suitable for use in the present invention are disclosed in WO 2017/075681.

### LIQUID LAUNDRY DETERGENTS

The term “laundry detergent” in the context of this invention denotes formulated compositions intended for and capable of wetting and cleaning domestic laundry such as clothing, linens and other household textiles. The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

Examples of liquid laundry detergents include heavy-duty liquid laundry detergents for use in the wash cycle of automatic washing machines, as well as liquid fine wash and liquid colour care detergents such as those suitable for washing delicate garments (e.g. those made of silk or wool) either by hand or in the wash cycle of automatic washing machines.

The term “liquid” in the context of this invention denotes that a continuous phase or predominant part of the composition is liquid and that the composition is flowable at 15° C. and above. Accordingly, the term “liquid” may encompass emulsions, suspensions, and compositions having flowable yet stiffer consistency, known as gels or pastes. The viscosity of the composition may suitably range from about 200 to about 10,000 mPa.s at 25° C. at a shear rate of 21 sec⁻¹. This shear rate is the shear rate that is usually exerted on the liquid when poured from a bottle. Pourable liquid detergent compositions generally have a viscosity of from 200 to 1,500 mPa.s, preferably from 200 to 700 mPa.s.

Liquid detergent compositions which are pourable gels generally have a viscosity of from 1,500 mPa.s to 6,000 mPa.s, preferably from 1,500 mPa.s to 2,000 mPa.s.

A composition according to the invention may suitably have an aqueous continuous phase. By “aqueous continuous phase” is meant a continuous phase which has water as its basis.

A composition of the invention suitably comprises from 10 to 70%, preferably from 25 to 60%, and more preferably from 30 to 55% (by weight based on the total weight of the composition) of one or more detersive surfactants selected from non-soap anionic surfactants, nonionic surfactants and mixtures thereof.

The term “detersive surfactant” in the context of this invention denotes a surfactant which provides a detersive (i.e. cleaning) effect to laundry treated as part of a domestic laundering process.

Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

A preferred class of non-soap anionic surfactant for use in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Some alkyl sulfate surfactant (PAS) may be used, such as non-ethoxylated primary and secondary alkyl sulphates with an alkyl chain length of from 10 to 18.

Mixtures of any of the above described materials may also be used.

In a composition of the invention the total level of anionic surfactant may preferably range from 20 to 80% by weight based on the total weight of the surfactant.

Also commonly used in laundry liquid compositions are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule. However, we have found that alkyl ether sulphates have a deleterious effect on performance of such compositions for use as premixes as described herein and in such instance it is preferred that the level of any alkyl ether sulphate is from 0 to 10% wt. of the total level of surfactant, more preferably from 0 to 1% wt and most preferably zero.

Preferably, the composition comprises from 20 to 80% wt. non-ionic surfactant based on the total weight of surfactant. Nonionic surfactants for use in the invention are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

A further class of non-ionic surfactants include the alkyl poly glycosides and rhamnolipids.

Mixtures of any of the above described materials may also be used.

### Hydrotropes

A composition of the invention may incorporate non-aqueous carriers such as hydrotropes, cosolvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates). Mixtures of any of the above described materials may also be used.

Non-aqueous carriers, when included, may be present in an amount ranging from 0.1 to 20%, preferably from 3 to 15%, and more preferably from 3 to 12% (by weight based on the total weight of the composition).

Preferably, the hydrotrope is monopropylene glycol and is present at from 3 to 15% wt. of the composition, more preferably from 10 to 15% wt. of the composition.

### Cosurfactants

A composition of the invention may contain one or more cosurfactants (such as amphoteric (zwitterionic) and/or cationic surfactants) in addition to the non-soap anionic and/or nonionic detersive surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

Mixtures of any of the above described materials may also be used.

Preferably, the composition comprises PEG ester fatty acid. PEG fatty acid ester is included to modify the rheological performance of the composition particularly during dilution. Preferred PEG ester fatty acids include PEG 9 cocoate, PEG 32 and PEG 175.

Preferably, the PEG ester fatty acid is present at from 0.01-5.0% of the premix composition.

### Polyamines

The ethoxylated polyamines (EPEI) are generally linear or branched poly (>2) amines. The amines may be primary, secondary or tertiary. A single or a number of amine functions are reacted with one or more alkylene oxide groups to form a polyalkylene oxide side chain. The alkylene oxide can be a homopolymer (for example ethylene oxide) or a random or block copolymer. The terminal group of the alkylene oxide side chain can be further reacted to give an anionic character to the molecule (for example to give carboxylic acid or sulphonic acid functionality).

The liquid composition comprises from about 0.5% to about 5% polyamine, more preferably from 2.0 to 3.5% wt. of the composition. Preferably, the polyamine is a soil release agent comprising a polyamine backbone corresponding to the formula:

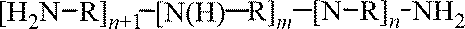

having a modified polyamine formula V(n+1)WmYnZ, or
a polyamine backbone corresponding to the formula:

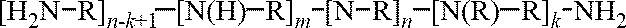

having a modified polyamine formula V(nk+1)WmYnY′kZ,
wherein k is less than or equal to n,

Preferably, the polyamine backbone prior to modification has a molecular weight greater than about 200 daltons.

Preferably,
i) V units are terminal units having the formula:

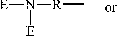

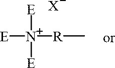

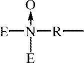

ii) sW units are backbone units having the formula

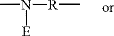

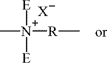

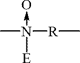

iii) Y units are branching units having the formula: and

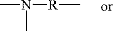

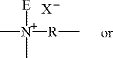

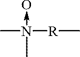

iv) Z units are terminal units having the formula:

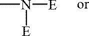

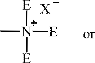

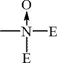

Preferably, backbone linking R units are selected from the group consisting of C2-C12 alkylene, -(R1O)×R3 (OR1)x-, -(CH₂CH(OR2)CH₂O)z(R1O)yR1(OCH₂CH(OR2)CH₂)w-, -CH₂CH(OR2)CH₂-and mixtures thereof,
provided that when R comprises C1-C12 alkylene R also comprises at least one -(R1O)xR3(OR1)x-, -(CH₂CH(OR2)CH₂O)z(R1O)yR1- (OCH₂CH(OR2)CH₂)w-, or -CH₂CH(OR2)CH₂-unit;
Preferably, R1 is C2-C6 alkylene and mixtures thereof;
Preferably, R2 is hydrogen, (R1O)XB, and mixtures thereof;
Preferably, R3 is C1-C12 alkylene, C3-C12 hydroxyalkylene, C4-C12 dihydroxy-alkylene, C8-C12 dialkylarylene, -C(O)-, -C(O)NHR5NHC(O)-, C(O)(R4)rC(O)-, -CH₂CH(OH)CH₂O(R1O)yR1O-CH₂CH(OH)CH₂-, and mixtures thereof;
Preferably, R4 is C1-C12 alkylene, C4-C12 alkenylene, C8-C12 arylalkylene, C6-C10 arylene, and mixtures thereof;
Preferably, R5 is C2-C12 alkylene or C6 C12 arylene;
Preferably, E units are selected from the group consisting of (CH₂)p-CO₂M, -(CH₂)qSO₃M, -CH(CH₂CO₂M)CO₂M, (CH₂)pPO₃M, -(R1O)xB, and mixtures thereof,
Preferably, B is hydrogen, -(CH₂)qSO₃M, -(CH₂)pCO₂M, -(CH₂)q CH(SO₃M)CH₂SO₃M, -(CH₂)qCH(SO₂M)CH₂SO₃M, - (CH2)pPO₃M, -PO₃M, and mixtures thereof,
Preferably, M is hydrogen or a water soluble cation in sufficient amount to satisfy charge balance;
Preferably X is a water soluble anion;
Preferably k has the value from 0 to about 20;
Preferably m has the value from 4 to about 400;
Preferably n has the value from 0 to about 200;
Preferably p has the value from 1 to 6,
Preferably q has the value from 0 to 6;
Preferably r has the value 0 or 1;
Preferably w has the value 0 or 1;
Preferably x has the value from 1 to 100;
Preferably y has the value from 0 to 100; and
Preferably z has the value 0 or 1.

### Builders

While the composition of the invention comprises MGDA, it is preferred that no other builder is present. Accordingly, compositions of the invention may contain from 0 to 1%, more preferably from 0 to 0.1% wt. one or more additional builders.

### Polymeric Cleaning Boosters

To further improve the environmental profile of liquid laundry detergents it may be preferred in some cases to reduce the volume of laundry detergent dosed per wash-load and to add various highly weight efficient ingredients to the composition to boost cleaning performance. In addition to the soil release polymers of the invention described above, a composition of the invention will preferably contain one or more additional polymeric cleaning boosters such as anti-redeposition polymers. Anti-redeposition polymers stabilise the soil in the wash solution thus preventing redeposition of the soil. Suitable soil release polymers for use in the invention include alkoxylated polyethyleneimines. Polyethyleneimines are materials composed of ethylene imine units -CH₂CH₂NH- and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone. Mixtures of any of the above described materials may also be used.

When included, a composition of the invention will preferably comprise from 0.25 to 8%, more preferably from 0.5 to 6% (by weight based on the total weight of the composition) of one or more anti-redeposition polymers such as, for example, the alkoxylated polyethyleneimines which are described above.

### Soil Release Polymers

Soil release polymers help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-endcapped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄alkylcelluloses and C₄hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

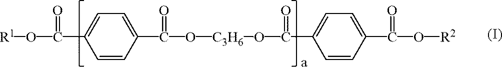

in which R¹ and R² independently of one another are X-(OC₂H₄)ₙ-(OC₃H₆)_{m;}
in which X is C₁₋₄ alkyl and preferably methyl;
n is a number from 12 to 120, preferably from 40 to 50;
m is a number from 1 to 10, preferably from 1 to 7; and
a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, preferably from 0.3 to 7%, more preferably from 0.5 to 5% (by weight based on the total weight of the composition).

Suitable soil release polymers are described in greater detail in U.S. Pat. Nos. 5,574,179; 4,956,447; 4,861,512; 4,702,857, WO 2007/079850 and WO2016/005271. If employed, soil release polymers will typically be incorporated into the liquid laundry detergent compositions herein in concentrations ranging from 0.01 percent to 10 percent, more preferably from 0.1 percent to 5 percent, by weight of the composition.

### Polymeric Thickeners

A composition of the inventions may comprise one or more polymeric thickeners. Suitable polymeric thickeners for use in the invention include hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂-C₂₂ alkyl) polyethoxylated (meth)acrylates; and (ii) at least one further monomer selected from C₁-C₄ alkyl (meth) acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

When included, a composition of the invention will preferably comprise from 0.1 to 5% (by weight based on the total weight of the composition) of one or more polymeric thickeners such as, for example, the HASE copolymers which are described above.

### Fluorescent Agents

It may be advantageous to include fluorescer in the compositions. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.5 wt %.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra, Tinopal 5BMGX, and Blankophor (Trade Mark) HRH, and Pyrazoline compounds, e.g. Blankophor SN.

Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfoslyryl)biphenyl.

### Shading Dyes

Shading dye can be used to improve the performance of the compositions. Preferred dyes are violet or blue. It is believed that the deposition on fabrics of a low level of a dye of these shades, masks yellowing of fabrics. A further advantage of shading dyes is that they can be used to mask any yellow tint in the composition itself.

Shading dyes are well known in the art of laundry liquid formulation.

Suitable and preferred classes of dyes are discussed below.

### Direct Dyes:

Direct dyes (otherwise known as substantive dyes) are the class of water soluble dyes which have an affinity for fibres and are taken up directly. Direct violet and direct blue dyes are preferred.

Preferably bis-azo or tris-azo dyes are used.

Most preferably, the direct dye is a direct violet of the following structures:

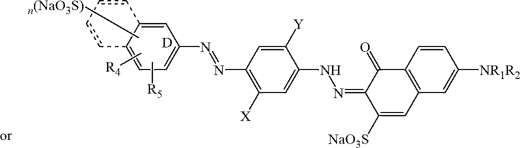

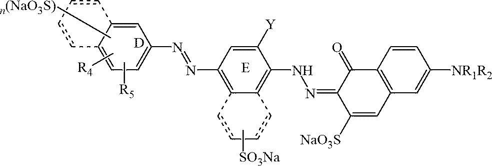

wherein:
ring D and E may be independently naphthyl or phenyl as shown;
R₁ is selected from: hydrogen and C₁-C₄-alkyl, preferably hydrogen;
R₂ is selected from: hydrogen, C₁-C₄-alkyl, substituted or unsubstituted phenyl and substituted or unsubstituted naphthyl, preferably phenyl;
R₃ and R₄ are independently selected from: hydrogen and C₁-C₄-alkyl, preferably hydrogen or methyl;
X and Y are independently selected from: hydrogen, C₁-C₄-alkyl and C₁-C₄-alkoxy; preferably the dye has X= methyl; and, Y = methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99. Bis-azo copper containing dyes for example direct violet 66 may be used. The benzidene based dyes are less preferred.

Preferably the direct dye is present at 0.000001 to 1 wt% more preferably 0.00001 wt% to 0.0010 wt% of the composition.

In another embodiment the direct dye may be covalently linked to the photo-bleach, for example as described in WO2006/024612.

### Acid Dyes:

Cotton substantive acid dyes give benefits to cotton containing garments. Preferred dyes and mixes of dyes are blue or violet. Preferred acid dyes are:

(i) azine dyes, wherein the dye is of the following core structure:

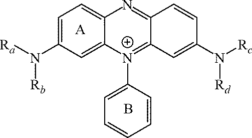

wherein Rₐ, R_{b}, R_{c} and R_{d} are selected from: H, a branched or linear C1 to C7-alkyl chain, benzyl a phenyl, and a naphthyl;
the dye is substituted with at least one SO₃⁻ or —COO⁻ group;
the B ring does not carry a negatively charged group or salt thereof; and
the A ring may further substituted to form a naphthyl; the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Other preferred non-azine acid dyes are acid violet 17, acid black 1 and acid blue 29.

Preferably the acid dye is present at 0.0005 wt% to 0.01 wt% of the formulation.

### Hydrophobic Dyes:

The composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0001 wt% to 0.005 wt% of the formulation.

### Basic Dyes:

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141.

### Reactive Dyes:

Reactive dyes are dyes which contain an organic group capable of reacting with cellulose and linking the dye to cellulose with a covalent bond. They deposit onto cotton.

Preferably the reactive group is hydrolysed or reactive group of the dyes has been reacted with an organic species for example a polymer, so as to the link the dye to this species. Dyes may be selected from the reactive violet and reactive blue dyes listed in the Colour Index International.

Preferred examples include reactive blue 19, reactive blue 163, reactive blue 182 and reactive blue, reactive blue 96.

### Dye Conjugates:

Dye conjugates are formed by binding direct, acid or basic dyes to polymers or particles via physical forces. Dependent on the choice of polymer or particle they deposit on cotton or synthetics. A description is given in WO2006/055787.

Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

Shading dye can be used in the absence of fluorescer, but it is especially preferred to use a shading dye in combination with a fluorescer, for example in order to reduce yellowing due to chemical changes in adsorbed fluorescer.

### External Structurants

Compositions of the invention may have their rheology further modified by use of one or more external structurants which form a structuring network within the composition. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

### Enzymes

A composition of the invention may comprise an effective amount of one or more enzyme selected from the group comprising, pectate lyase, protease, amylase, cellulase, lipase, mannanase and mixtures thereof. The enzymes are preferably present with corresponding enzyme stabilizers.

### Fragrances

Fragrances are well known in the art and may be incorporated into compositions described herein.

### Microcapsules

One type of microparticle suitable for use in the invention is a microcapsule. Microencapsulation may be defined as the process of surrounding or enveloping one substance within another substance on a very small scale, yielding capsules ranging from less than one micron to several hundred microns in size. The material that is encapsulated may be called the core, the active ingredient or agent, fill, payload, nucleus, or internal phase. The material encapsulating the core may be referred to as the coating, membrane, shell, or wall material.

Microcapsules typically have at least one generally spherical continuous shell surrounding the core. The shell may contain pores, vacancies or interstitial openings depending on the materials and encapsulation techniques employed. Multiple shells may be made of the same or different encapsulating materials, and may be arranged in strata of varying thicknesses around the core. Altematively, the microcapsules may be asymmetrically and variably shaped with a quantity of smaller droplets of core material embedded throughout the microcapsule.

The shell may have a barrier function protecting the core material from the environment external to the microcapsule, but it may also act as a means of modulating the release of core materials such as fragrance. Thus, a shell may be water soluble or water swellable and fragrance release may be actuated in response to exposure of the microcapsules to a moist environment. Similarly, if a shell is temperature sensitive, a microcapsule might release fragrance in response to elevated temperatures. Microcapsules may also release fragrance in response to shear forces applied to the surface of the microcapsules.

A preferred type of polymeric microparticle suitable for use in the invention is a polymeric core-shell microcapsule in which at least one generally spherical continuous shell of polymeric material surrounds a core containing the fragrance formulation (f2). The shell will typically comprise at most 20% by weight based on the total weight of the microcapsule. The fragrance formulation (f2) will typically comprise from about 10 to about 60% and preferably from about 20 to about 40% by weight based on the total weight of the microcapsule. The amount of fragrance (f2) may be measured by taking a slurry of the microcapsules, extracting into ethanol and measuring by liquid chromatography.

Polymeric core-shell microcapsules for use in the invention may be prepared using methods known to those skilled in the art such as coacervation, interfacial polymerization, and polycondensation.

The process of coacervation typically involves encapsulation of a generally water-insoluble core material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration.

Interfacial polymerisation typically proceeds with the formation of a fine dispersion of oil droplets (the oil droplets containing the core material) in an aqueous continuous phase. The dispersed droplets form the core of the future microcapsule and the dimensions of the dispersed droplets directly determine the size of the subsequent microcapsules. Microcapsule shell-forming materials (monomers or oligomers) are contained in both the dispersed phase (oil droplets) and the aqueous continuous phase and they react together at the phase interface to build a polymeric wall around the oil droplets thereby to encapsulate the droplets and form core-shell microcapsules. An example of a core-shell microcapsule produced by this method is a polyurea microcapsule with a shell formed by reaction of diisocyanates or polyisocyanates with diamines or polyamines.

Polycondensation involves forming a dispersion or emulsion of the core material in an aqueous solution of precondensate of polymeric materials under appropriate conditions of agitation to produce capsules of a desired size, and adjusting the reaction conditions to cause condensation of the precondensate by acid catalysis, resulting in the condensate separating from solution and surrounding the dispersed core material to produce a coherent film and the desired microcapsules. An example of a core-shell microcapsule produced by this method is an aminoplast microcapsule with a shell formed from the polycondensation product of melamine (2,4,6-triamino-1,3,5-triazine) or urea with formaldehyde. Suitable cross-linking agents (e.g. toluene diisocyanate, divinyl benzene, butanediol diacrylate) may also be used and secondary wall polymers may also be used as appropriate, e.g. anhydrides and their derivatives, particularly polymers and co-polymers of maleic anhydride.

One example of a preferred polymeric core-shell microcapsule for use in the invention is an aminoplast microcapsule with an aminoplast shell surrounding a core containing the fragrance formulation (f2). More preferably such an aminoplast shell is formed from the polycondensation product of melamine with formaldehyde.

Polymeric microparticles suitable for use in the invention will generally have an average particle size between 100 nanometers and 50 microns. Particles larger than this are entering the visible range. Examples of particles in the sub-micron range include latexes and mini-emulsions with a typical size range of 100 to 600 nanometers. The preferred particle size range is in the micron range. Examples of particles in the micron range include polymeric core-shell microcapsules (such as those further described above) with a typical size range of 1 to 50 microns, preferably 5 to 30 microns. The average particle size can be determined by light scattering using a Malvern Mastersizer with the average particle size being taken as the median particle size D (0.5) value. The particle size distribution can be narrow, broad or multimodal. If necessary, the microcapsules as initially produced may be filtered or screened to produce a product of greater size uniformity.

Polymeric microparticles suitable for use in the invention may be provided with a deposition aid at the outer surface of the microparticle. Deposition aids serve to modify the properties of the exterior of the microparticle, for example to make the microparticle more substantive to a desired substrate. Desired substrates include cellulosics (including cotton) and polyesters (including those employed in the manufacture of polyester fabrics).

The deposition aid may suitably be provided at the outer surface of the microparticle by means of covalent bonding, entanglement or strong adsorption. Examples include polymeric core-shell microcapsules (such as those further described above) in which a deposition aid is attached to the outside of the shell, preferably by means of covalent bonding. While it is preferred that the deposition aid is attached directly to the outside of the shell, it may also be attached via a linking species.

Deposition aids for use in the invention may suitably be selected from polysaccharides having an affinity for cellulose. Such polysaccharides may be naturally occurring or synthetic and may have an intrinsic affinity for cellulose or may have been derivatised or otherwise modified to have an affinity for cellulose. Suitable polysaccharides have a 1-4 linked β glycan (generalised sugar) backbone structure with at least 4, and preferably at least 10 backbone residues which are β1-4 linked, such as a glucan backbone (consisting of β1-4 linked glucose residues), a mannan backbone (consisting of β1-4 linked mannose residues) or a xylan backbone (consisting of β1-4 linked xylose residues). Examples of such β1-4 linked polysaccharides include xyloglucans, glucomannans, mannans, galactomannans, β(1-3),(1-4) glucan and the xylan family incorporating glucurono-, arabino- and glucuronoarabinoxylans. Preferred β1-4 linked polysaccharides for use in the invention may be selected from xyloglucans of plant origin, such as pea xyloglucan and tamarind seed xyloglucan (TXG) (which has a β1-4 linked glucan backbone with side chains of α-D xylopyranose and β-D-galactopyranosyl-(1-2)-α-D-xylo-pyranose, both 1-6 linked to the backbone); and galactomannans of plant origin such as loc ust bean gum (LBG) (which has a mannan backbone of β1-4 linked mannose residues, with single unit galactose side chains linked α1-6 to the backbone).

Also suitable are polysaccharides which may gain an affinity for cellulose upon hydrolysis, such as cellulose mono-acetate; or modified polysaccharides with an affinity for cellulose such as hydroxypropyl cellulose, hydroxypropyl methylcellulose, hydroxyethyl methylcellulose, hydroxypropyl guar, hydroxyethyl ethylcellulose and methylcellulose.

Deposition aids for use in the invention may also be selected from phthalate containing polymers having an affinity for polyester. Such phthalate containing polymers may have one or more nonionic hydrophilic segments comprising oxyalkylene groups (such as oxyethylene, polyoxyethylene, oxypropylene or polyoxypropylene groups), and one or more hydrophobic segments comprising terephthalate groups. Typically, the oxyalkylene groups will have a degree of polymerization of from 1 to about 400, preferably from 100 to about 350, more preferably from 200 to about 300. A suitable example of a phthalate containing polymer of this type is a copolymer having random blocks of ethylene terephthalate and polyethylene oxide terephthalate.

Mixtures of any of the above described materials may also be suitable.

Deposition aids for use in the invention will generally have a weight average molecular weight (M_{w}) in the range of from about 5 kDa to about 500 kDa, preferably from about 10 kDa to about 500 kDa and more preferably from about 20 kDa to about 300 kDa.

One example of a particularly preferred polymeric core-shell microcapsule for use in the invention is an aminoplast microcapsule with a shell formed by the polycondensation of melamine with formaldehyde; surrounding a core containing the fragrance formulation (f2); in which a deposition aid is attached to the outside of the shell by means of covalent bonding. The preferred deposition aid is selected from β1-4 linked polysaccharides, and in particular the xyloglucans of plant origin, as are further described above.

The present inventors have surprisingly observed that it is possible to reduce the total level of fragrance included in the composition of the invention without sacrificing the overall fragrance experience delivered to the consumer at key stages in the laundry process. A reduction in the total level of fragrance is advantageous for cost and environmental reasons.

Accordingly, the total amount of fragrance formulation (f1) and fragrance formulation (f2) in the composition of the invention suitably ranges from 0.5 to 1.4%, preferably from 0.5 to 1.2%, more preferably from 0.5 to 1% and most preferably from 0.6 to 0.9% (by weight based on the total weight of the composition).

The weight ratio of fragrance formulation (f1) to fragrance formulation (f2) in the composition of the invention preferably ranges from 60:40 to 45:55. Particularly good results have been obtained at a weight ratio of fragrance formulation (f1) to fragrance formulation (f2) of around 50:50.

The fragrance (f1) and fragrance (f2) are typically incorporated at different stages of formation of the composition of the invention. Typically, the discrete polymeric microparticles (e.g. microcapsules) entrapping fragrance formulation (f2) are added in the form of a slurry to a warmed base formulation comprising other components of the composition (such as surfactants and solvents). Fragrance (f1) is typically post-dosed later after the base formulation has cooled.

### Further Optional Ingredients

A composition of the invention may contain further optional ingredients to enhance performance and/or consumer acceptability. Examples of such ingredients include foam boosting agents, preservatives (e.g. bactericides), polyelectrolytes, anti-shrinking agents, anti-wrinkle agents, antioxidants, sunscreens, anti-corrosion agents, drape imparting agents, anti-static agents, ironing aids, colorants, pearlisers and/or opacifiers, and shading dye. Each of these ingredients will be present in an amount effective to accomplish its purpose. Generally, these optional ingredients are included individually at an amount of up to 5% (by weight based on the total weight of the composition).

Many of the ingredients used in embodiments of the invention may be obtained from so called black carbon sources or a more sustainable green source. The following provides a list of alternative sources for several of these ingredients and how they can be made into raw materials described herein.

### SLES and PAS

SLES and other such alkali metal alkyl ether sulphate anionic surfactants are typically obtainable by sulphating alcohol ethoxylates. These alcohol ethoxylates are typically obtainable by ethoxylating linear alcohols. Similarly, primary alkyl sulphate surfactants (PAS) can be obtained from linear alcohols directly by sulphating the linear alcohol. Accordingly, forming the linear alcohol is a central step in obtaining both PAS and alkali-metal alkyl ether sulphate surfactants.

The linear alcohols which are suitable as an intermediate step in the manufacture of alcohol ethoxylates and therefore anionic surfactants such as sodium lauryl ether sulphate ca be obtained from many different sustainable sources. These include:

### Primary Sugars

Primary sugars are obtained from cane sugar or sugar beet, etc., and may be fermented to form bioethanol. The bioethanol is then dehydrated to form bio-ethylene which then undergoes olefin methathesis to form alkenes. These alkenes are then processed into linear alcohols either by hydroformylation or oxidation.

An alternative process also using primary sugars to form linear alcohols can be used and where the primary sugar undergoes microbial conversion by algae to form triglycerides. These triglycerides are then hydrolysed to linear fatty acids and which are then reduced to form the linear alcohols.

### Biomass

Biomass, for example forestry products, rice husks and straw to name a few may be processed into syngas by gasification. Through a Fischer Tropsch reaction these are processed into alkanes, which in turn are dehydrogenated to form olefins. These olefins may be processed in the same manner as the alkenes described above [primary sugars].

An alternative process turns the same biomass into polysaccharides by steam explosion which may be enzymatically degraded into secondary sugars. These secondary sugars are then fermented to form bioethanol which in turn is dehydrated to form bio-ethylene. This bio-ethylene is then processed into linear alcohols as described above [primary sugars].

### Waste Plastics

Waste plastic is pyrolyzed to form pyrolysed oils. This is then fractioned to form linear alkanes which are dehydrogenated to form alkenes. These alkenes are processed as described above [primary sugars].

Altematively, the pyrolyzed oils are cracked to form ethylene which is then processed to form the required alkenes by olefin metathesis. These are then processed into linear alcohols as described above [primary sugars].

### Municipal Solid Waste

MSW is tumed into syngas by gasification. From syngas it may be processed as described above [primary sugars] or it may be tumed into ethanol by enzymatic processes before being dehydrogenated into ethylene. The ethylene may then be tumed into linear alcohols by the Ziegler Process.

The MSW may also be tumed into pyrolysis oil by gasification and then fractioned to form alkanes. These alkanes are then dehydrogenated to form olefins and then linear alcohols.

### Marine Carbon

There are various carbon sources from marine flora such as seaweed and kelp. From such marine flora the triglycerides can be separated from the source and which is then hydrolysed to form the fatty acids which are reduced to linear alcohols in the usual manner.

Altematively, the raw material can be separated into polysaccharides which are enzymatically degraded to form secondary sugars. These may be fermented to form bio-ethanol and then processed as described above [Primary Sugars].

### Waste Oils

Waste oils such as used cooking oil can be physically separated into the triglycerides which are split to form linear fatty acids and then linear alcohols as described above.

Altematively, the used cooking oil may be subjected to the Neste Process whereby the oil is catalytically cracked to form bio-ethylene. This is then processed as described above.

### Methane Capture

Methane capture methods capture methane from landfill sites or from fossil fuel production. The methane may be formed into syngas by gasification. The syngas may be processed as described above whereby the syngas is turned into methanol (Fischer Tropsch reaction) and then olefins before being tumed into linear alcohols by hydroformylation oxidation.

Altematively, the syngas may be tumed into alkanes and then olefins by Fischer Tropsch and then dehydrogenation.

### Carbon Capture

Carbon dioxide may be captured by any of a variety of processes which are all well known. The carbon dioxide may be tumed into carbon monoxide by a reverse water gas shift reaction and which in turn may be tumed into syngas using hydrogen gas in an electrolytic reaction. The syngas is then processed as described above and is either turned into methanol and/or alkanes before being reacted to form olefins.

Altematively, the captured carbon dioxide is mixed with hydrogen gas before being enzymatically processed to form ethanol. This is a process which has been developed by Lanzatech. From here the ethanol is turned into ethylene and then processed into olefins and then linear alcohols as described above.

### Las

One of the other main surfactants commonly used in cleaning compositions, in particular laundry compositions is LAS (linear alkyl benzene sulphonate).

The key intermediate compound in the manufacture of LAS is the relevant alkene. These alkenes (olefins) may be produced by any of the methods described above and may be formed from primary sugars, biomass, waste plastic, MSW, carbon capture, methane capture, marine carbon to name a few.

Whereas in the processed described above the olefin is processed to form linear alcohols by hydroformylation and oxidation instead, the olefin is reacted with benzene and then sulphonate to form the LAS.

### Packaging and Dosing

A composition of the invention may be packaged as unit doses in polymeric film soluble in the wash water. Alternatively, a composition of the invention may be supplied in multidose plastics packs with a top or bottom closure. A dosing measure may be supplied with the pack either as a part of the cap or as an integrated system.

A method of laundering fabric using a composition of the invention will usually involve diluting the dose of detergent composition with water to obtain a wash liquor and washing fabrics with the wash liquor so formed.

The dilution step preferably provides a wash liquor which comprises inter alia from about 3 to about 20 g/wash of detersive surfactants (as are further defined above).

In automatic washing machines the dose of detergent composition is typically put into a dispenser and from there it is flushed into the machine by the water flowing into the machine, thereby forming the wash liquor. From 5 up to about 65 litres of water may be used to form the wash liquor depending on the machine configuration. The dose of detergent composition may be adjusted accordingly to give appropriate wash liquor concentrations. For example, dosages for a typical front-loading washing machine (using 10 to 15 litres of water to form the wash liquor) may range from about 10 ml to about 60 ml, preferably about 15 to 40 ml. Dosages for a typical top-loading washing machine (using from 40 to 60 litres of water to form the wash liquor) may be higher, e.g. up to about 100 ml.

A subsequent aqueous rinse step and drying the laundry is preferred.

The consumer may add water to the concentrated premix, or alternatively concentrated premix to the water depending on the preferred consumer behaviour in any particular market. Where the premix is added to water, the premix is made available to the consumer in a regular pack conforming with the volume of the premix purchased. In such instances it is preferred that the packaged premix is available with an appropriately dimensioned dilution container in which water is added from a domestic supply and to which the premix is added to form the functional liquid detergent composition.

Preferably, by diluting said premix 0.8 to 1 to 10 to 1 in water (water to premix). The degree of dilution is also dependent on market choice. In some markets a more concentrated product is desired while in others a more dilute product is preferred. The amount of water instructed to be used is thus variable but it is preferred that the dilution is at least 1:1 and preferably no more than 5 to 1, water to concentrated premix.

In a third aspect there is provided a container comprising a premix as described in the first aspect. Containers include bottles, tottles, sealable bags and doy-packs and such like. Preferably, the container has an orifice which may provide means for adding water from a domestic supply to the container containing a concentrated premix. It is also preferred that the container comprises a means for adding water to the container and a separate means for permitting diluted contents to be dispensed. In such an embodiment the means for adding water is preferably near the top of the container when in a standing disposition and the means for permitting diluted contents to be dispensed is disposed near the bottom in the same disposition.

The container may also be of an expansible type wherein the container as purchased by the consumer is to be expanded before dilution with water from a domestic supply.

For example, the consumer purchases a container which is folded such that it contains a first volume of concentrated premix and is optionally packaged within a secondary package such that the consumer sees only a regular box or carton. Inside such secondary pack is a bag or other such container and which contains the premix. Water is added from a domestic supply and the concentrate is thus diluted to form the liquid laundry treatment composition which can be used in a regular way by the consumer. For example, it may be added to a shuttle device and placed inside a washing machine drum or it may be dispensed into a washing machine drawer.

The water supplied may also be filtered prior to use. This is at the consumer’s discretion, but it is expected that the concentrated premix described herein is suitable for a wide variety of water hardnesses.

Preferably, the container displaces a volume appropriate to permit dilution of said premix to form a liquid detergent composition at an appropriate dilution. For example, container may have internal volume (V) and the premix supplied in the container may have volume V/3. In such an embodiment the consumer will be directed to add two parts of water to one part of premix such that the volume of diluted premix is substantially equal to V.

### EXAMPLES

The following is a formulation according to the invention and are manufactured using standard protocols. Shown is the formulation before and after dilution with water by the consumer.

| | Pre-dilution | Post-dilution |
|---|---|---|
| Ingredient | wt% | wt% |
| Demin Water | 26.3435 | 13.17175 |
| Consumer Water | 0 | 50 |
| Optical Brightener | 0.21 | 0.105 |
| MPG | 12.5 | 6.25 |
| Nonionic Surfactant | 26.292 | 13.146 |
| Glycerol | 0.5 | 0.25 |
| TEA | 2.5 | 1.25 |
| NaOH | 2.07 | 1.035 |
| LAS Acid | 17.528 | 8.764 |
| Fatty Acid | 1.62 | 0.81 |
| Sorbeth ethoxylated ester | 4.5 | 2.25 |
| MGDA | 0.5 | 0.25 |
| Polyamine | 2.49 | 1.245 |
| SRP | 0.3 | 0.15 |
| Preservative | 0.0095 | 0.00475 |
| Preservative | 0.045 | 0.0225 |
| Fragrance | 2.592 | 1.296 |
| | 100 | 100 |
| pH | | 7.0 |

The following shows the results from a three day stability assessment of the pre-diluted product.

| | | | | | |
|---|---|---|---|---|---|
| Ingredient (0.5 wt% in conc) SOU2-UK non-bio | Concentrated liquid FA = 1.62 wt% pH ~6.7 | Diluted in Prenton water [26FH 2:1] / 5° C. | Diluted in Prenton water [26FH 2:1] / 25° C. | Diluted in mocked up water [40FH 4:1] / 5° C. | Diluted in mocked up water [40FH 4:1] / 25° C. |
| Control - none | Clear | Clear | Clear | Hazy | Clear |
| Trilon M Max (MGDA) | Clear | Clear | Clear | Clear | Clear |
| Dequest 2066 | Hazy | Clear | Clear | Hazy | Clear |

[26FH 2:1] means 26° French Hardness and with 2:1 Ca to Mg.

The premix containing Dequest 2066 is hazy and forms an unstable system. Unexpectedly, the presence of 0.5 wt% MGDA the formulation is clear, suggesting MDGA improves the diluted product stability.

1. A concentrated laundry detergent composition premix comprising 10 to 70% wt. surfactant, a fatty acid, and methyl glycine diacetic acid (MGDA), from 3 to 15% wt. hydrotrope, and having a pH of from 6 to 8.

2. Composition according to claim 1 wherein the MGDA is present at from 0.1 to 3% wt. of the concentrated laundry detergent composition.

3. Composition according to claim 1 wherein the fatty acid is present at from 1 to 4% wt. of the concentrated laundry detergent composition.

4. Composition according to claim 1 wherein the composition comprises rheology modifier.

5. Composition according to claim 1 having a viscosity measure at 21 s⁻¹ and at 25° C. of from 100 to 700 mPa.s.

6. Composition according to claim 1 wherein the composition comprises from 0 to 10% wt. the total surfactant, alkyl ether sulphate.

7. A method for forming a laundry detergent composition by diluting a premix as claimed in claim 1 in water such that the final concentration of fatty acid is from 0.5 to 1.5% wt.

8. A method for forming a laundry detergent composition by diluting a premix as claimed in claim 1, in water at from 0.8 to 1 to 10 to 1 (water to premix).

9. A container comprising a premix as claimed in claim 1.

10. A container according to claim 9 wherein the container displaces a volume appropriate to permit dilution of said premix to form a liquid detergent composition at an appropriate dilution.
